(19) United States
(12) Patent Application Publication
(10) Pub. No.: US 2009/0106236 A1
(43) Pub. Date: Apr. 23, 2009

(54) Method for scoring products, services, institutions, and other items

(75) Inventors: Eric Bruce Koefoot, Oakton, VA (US); Daniel Edward Harrison, Reston, VA (US); Chad Christopher Smolinski, Great Falls, VA (US); Evan Louis Jones, Washington, DC (US)

Correspondence Address: CURTIS, MALLET-PREVOST, COLT & MOSLE, LLP, 101 PARK AVENUE, 34TH FLOOR, NEW YORK, NY, 10178-0061, US

(73) Assignee: US News R&R, LLC, New York, NY (US)

(21) Appl. No.: 12/220,589

(22) Filed: Jul. 25, 2008

Related U.S. Application Data
(60) Provisional application No. 60/935,074, filed on Jul. 25, 2007.

(51) Int. Cl. G06F 7/06; G06F 17/30

(52) U.S. Cl. 707/5; 707/E17.014

(57) ABSTRACT

The present invention relates to a method of scoring an item, including reviewing a first editorial evaluation of the item; assigning a first editorial evaluation score to the item based on the first editorial evaluation; reviewing a second editorial evaluation of the item; assigning a second editorial evaluation score to the item based on the second editorial evaluation; and calculating a score for the item based on the first editorial evaluation score and the second editorial evaluation score. The item score may also be calculated based upon component scores for the item or quantitative ratings.

This application claims priority from U.S. provisional patent application Ser. No. 60/935,074, filed Jul. 25, 2007.

### BACKGROUND

A diverse range of informative materials are available to a consumer when comparison shopping for an item, such as a product (e.g., a car, or appliance), a service (e.g., a restaurant or investment broker), or an institution (e.g., a college). For example, the consumer can read reviews of the item in magazines such as Consumer Reports, or in books such as the Zagat Survey. In addition, the consumer can read reviews of the item in articles published in newspapers or on various Internet sites, such as Epinions.com or Edmunds.com. However, in many cases, it may be difficult for the consumer to determine whether the reviews were written by competent, credible, and independent experts in the relevant field. In addition, it may be difficult for the consumer to resolve conflicts between favorable and unfavorable evaluations of the same item.

Another category of informative materials available to the consumer is ratings provided by, for example, government agencies, private companies, and other organizations. As an example, a consumer in the market for a refrigerator can review the efficiency ratings for the refrigerator, or can review safety ratings for the refrigerator published by the U.S. Consumer Product Safety Commission (“USCPSC”). Or, a consumer in the market for an automobile can review the safety ratings published by the National Highway Traffic Safety Administration (“NHTSA”) or the Insurance Institute for Highway Safety (“IIHS”). However, considering multiple evaluations and/or ratings for a given item can be time consuming and confusing to the consumer.

Therefore, there exists a need in the art for a single source of information that provides a cumulative score and/or ranking for an item of interest, based on various existing evaluations and/or ratings from credible sources.

### SUMMARY

This patent application relates to a method that can be used to assimilate potentially complex information from multiple sources, and typically in multiple formats, in order to condense and organize the information into a single-source, consumer-friendly format.

According to an exemplary embodiment, a method of scoring an item comprises reviewing a first editorial evaluation of the item; assigning a first editorial evaluation score to the item based on the first editorial evaluation; reviewing a second editorial evaluation of the item; assigning a second editorial evaluation score to the item based on the second editorial evaluation; and calculating a score for the item based on the first editorial evaluation score and the second editorial evaluation score.

According to another exemplary embodiment, a method of scoring an item comprises reviewing a first editorial evaluation of the item; assigning a first editorial evaluation score to the item based on the first editorial evaluation; obtaining a first quantitative rating of the item; and calculating a score for the item based on the first editorial evaluation score, and the first quantitative rating for the item.

According to yet another exemplary embodiment, a method of scoring an item comprises obtaining a first quantitative rating of the item; obtaining a second quantitative rating of the item; and calculating a score for the item based on the first quantitative rating and the second quantitative rating.

Further features of the method, as well as the structure and operation of various embodiments, are described in detail below with reference to the accompanying drawings.

### BRIEF DESCRIPTION OF THE DRAWINGS

The foregoing and other features will be apparent from the following, more particular description of exemplary embodiments, as illustrated in the accompanying drawings wherein like reference numbers generally indicate identical, functionally similar, and/or structurally similar elements.

FIG. 1 depicts a flow chart for an exemplary embodiment of the invention.

FIG. 2 depicts an exemplary computer system that can be used with exemplary embodiments of the invention.

FIG. 3 depicts an exemplary architecture that can be used to implement the exemplary computer system of FIG. 2.

### DEFINITIONS

In describing the invention, the following definitions are applicable throughout (including above).

A “computer” may refer to one or more apparatuses and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, or a chip set; a system-on-chip (SoC) or a multiprocessor system-on-chip (MPSoC); an optical computer; a quantum computer; a biological computer; and an apparatus that may accept data, may process data in accordance with one or more stored software programs, may generate results, and typically may include input, output, storage, arithmetic, logic, and control units.

“Software” may refer to prescribed rules to operate a computer. Examples of software may include: software; code segments; instructions; applets; pre-compiled code; compiled code; computer programs; firmware; and programmed logic.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a memory chip; other magnetic, optical or biological recordable media; and/or other types of media that can store machine-readable instructions thereon.

A “computer system” may refer to a system having one or more computers, where each computer may include a computer-readable medium embodying software to operate the computer. Examples of a computer system may include: a distributed computer system for processing information via computer systems linked by a network; two or more computer systems connected together via a network for transmitting and/or receiving information between the computer systems; and one or more apparatuses and/or one or more systems that may accept data, may process data in accordance with one or more stored software programs, may generate results, and typically may include input, output, storage, arithmetic, logic, and control units.

### DETAILED DESCRIPTION OF EXEMPLARY EMBODIMENTS

Exemplary embodiments of the invention are discussed in detail below. While specific exemplary embodiments are discussed, it should be understood that this is done for illustration purposes only. In describing and illustrating the exemplary embodiments, specific terminology is employed for the sake of clarity. However, the invention is not intended to be limited to the specific terminology so selected. A person skilled in the relevant art will recognize that other components and configurations may be used without departing from the spirit and scope of the invention. It is to be understood that each specific element includes all technical equivalents that operate in a similar manner to accomplish a similar purpose. Each reference cited herein is incorporated by reference. The examples and embodiments described herein are non-limiting examples.

Overview of Scoring and Ranking Method

According to an exemplary embodiment, the present invention provides a method of analyzing, manipulating, and combining various items of third party information to score and/or rank comparable items. The method can apply to consumer products such as cars, appliances, or electronics; services such as restaurants and financial companies; and institutions such as colleges, charities, and businesses. The method can also be utilized in a business context for scoring and/or ranking various items, such as industry product suppliers and service providers, or for scoring and/or ranking locations to do business in, such as cities, states, and countries. For ease of understanding, an exemplary embodiment of the methodology will be described with reference to the consumer item of cars, however, the method described herein can apply generally across multiple categories of items. One of ordinary skill in the art will understand, however, that variations may be necessary to tailor the process to certain items.

An exemplary embodiment of the method creates a score or set of scores for one or more items. The items can all be within a similar category. For example, with respect to cars, the method may create a set of scores for “upscale midsize cars” or for “affordable small cars” or for “minivans.”

According to an exemplary embodiment, the term “score” can be a number on a scale of 0-10 (0=lowest, 10=highest) representing how well the item performs on certain dimensions. One of ordinary skill in the art will understand that other scales are also possible, e.g., 1-5. One possible type of score is a “component score,” which can represent a specific attribute or group of attributes of the item. For example, with respect to cars, some examples of component scores can include a reliability score, a safety score, or a performance score. A particular car may receive a reliability score of 6.3, a safety score of 8.5, and a performance score of 7.2.

Another possible type of score is an “overall score,” which can reflect the score of the item in general. The overall score may, or may not, be based on a variety of underlying component scores. For example, the car with the component scores mentioned above may receive an overall score of 7.0 out of 10. The overall score may be based upon the component scores being considered equal or weighted to give certain component scores a greater value or significance in the overall score.

An exemplary embodiment of the method can also rank items against one another. For example, items within the same category (e.g., upscale midsize cars) can be rank-ordered against one another, for example, based on each item's overall score. An item's location within the category may be referred to as its “ranking” (i.e., the best item in the category receives a ranking of 1, while the fifth-best item in the category receives a ranking of 5). Items within a category can additionally or alternatively be ranked based on one or more of their component scores. Items can additionally or alternatively be ranked against other items in different, but similar categories (e.g., upscale midsize cars, affordable small cars, and minivans may be lumped together and rank-ordered against one another).

According to an exemplary embodiment, the method can generate component scores and/or overall scores for various items based on quantitative ratings of the items that are obtained from third party tests or evaluations of the item (e.g., safety scores published by the USCPSC or NHTSA). Additionally or alternatively, the method can generate component scores and/or overall scores for the items based on analysis of editorial evaluations of the items (e.g. prose-based reviews of the item, such as the reviews published in magazines, newspapers, and on the internet).

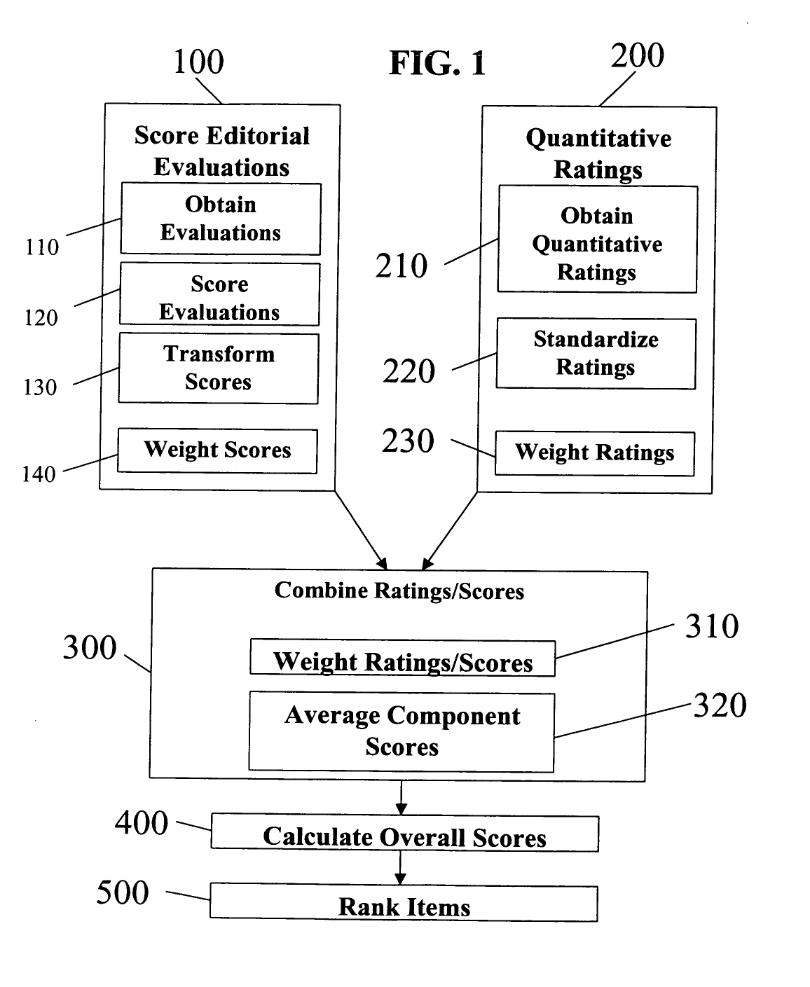

As shown in FIG. 1, an exemplary embodiment of the methodology can comprise the steps of scoring the editorial evaluations (block 100), obtaining the quantitative ratings (block 200), and combining the editorial evaluation scores with the quantitative ratings to obtain an overall score, and/or or a set of component scores, for each item being scored (blocks 300 and 400). The method can also comprise the step of ranking multiple items against one another (block 500). The steps of the method are not limited to the order shown in FIG. 1. For example, steps 100 and 200 can be performed in parallel or in succession. In addition, the method is not limited to combining editorial evaluation scores with quantitative ratings. Rather, the method can rely solely on the editorial evaluation scores or on the quantitative ratings. The method is also not limited to calculating overall scores based on underlying component scores. Rather, the method can be used to calculate an overall score independent of any underlying component scores. This may apply, for example, to simple items.

Scoring of Editorial Evaluations

An exemplary embodiment of scoring third-party editorial evaluations is shown in block 100. Editorial evaluations generally include word-based or prose-based qualitative reviews of the items, typically in descriptive form, which describe and/or compare various aspects of the items. Some examples of an editorial evaluation include a car review in Road and Track magazine, an appliance review in Consumer Reports magazine, or a review of a restaurant in a magazine or newspaper. Additional examples include product reviews posted on the Internet, such as those posted by a service provider such as Epinions.com, or those posted by individual consumers based on experience with the item.

The process of scoring editorial evaluations can begin by locating reviews for the item from a list of preferred editorial evaluation sources, as represented by block 110. This step can be performed manually by a human being, automatically by a computer using keywords or other search terms, or by some combination of the two. The list of preferred editorial evaluation sources can represent those sources of reviews that consumers should and/or do use for finding information about the item of interest, for example, those with an established track record of providing useful and accurate information. Factors to be considered when creating the list of preferred sources can include the popularity of the source (e.g., circulation rate, size of readership, number of unique visitors), the level of research performed by the source, whether the source is trusted within the public and within industry, or some other form of source valuation methodology (i.e., it has consumer buzz). The list can be reviewed and amended on an ongoing basis to represent only the most trusted, popular, and analytically rigorous sources of editorial evaluations for the item of interest.

Block 120 represents an exemplary step of scoring the editorial evaluations. The editorial evaluations located in step 110 for a given item can be reviewed and used to assign numerical scores to the item (e.g., to each of the component scores or to the overall score). Since the editorial evaluations are primarily word-based or prose-based (e.g., words, phrases, or sentences describing the various attributes of the item), the step 120 of scoring the editorial evaluations can include reading or processing the editorial evaluations, and assigning one or more numerical scores (e.g., component scores or an overall score) to each item based on the descriptive and comparative content about the item covered by the evaluation. Each editorial evaluation typically generates its own overall score and/or set of component scores each item reviewed therein. In the case where a single editorial evaluation covers multiple items, that review will typically generate an overall score, and/or a set of component scores, for each item reviewed therein.

It should be noted that some editorial evaluations may also include numbered scores, or some other form of scaled score (e.g., numbers of stars, words such as “poor”, “good”, and “best”) in addition to written qualitative reviews about the various properties of the item. In this case, the numerical score(s) assigned to the item in step 120 of the present method can take into consideration both what is written about the item in words in the editorial evaluation, and the quantitative or numbered score(s) assigned to the item by the editorial evaluation.

The step 120 of scoring the editorial evaluations can be performed manually by a human, automatically by a computer, or by some combination of the two. In the case of manual scoring by a person, a single reviewer can score all of the editorial evaluations for items within a single comparison category (e.g., upscale midsize cars) to avoid scorer bias. Additionally or alternatively, one or more reviewers can follow a set of guidelines (e.g., a scoring guidelines document) in order to obtain consistent scores based on what is written in a given editorial evaluation. The set of guidelines may set out a series of rules for how and when to apply scores based upon the written content in the editorial evaluations. For example, there may be certain topics, words, or concepts that need to be present in the evaluation in order to obtain a given score, for overall and/or component scores. Additionally or alternatively, all reviewers can be tested at least once a week as a group to ensure that all reviewers are assigning scores consistently.

In the case where step 120 is performed by a computer, the computer can read the editorial evaluations and use logic rules (e.g., the proximity of certain words to one another, semantics, context, etc.) to determine numerical scores based on the words present in the evaluation. A set or database of rules may be used to direct the computer to determine numerical scores for the editorial evaluation or parts thereof. For example, the computer may take into consideration the proximity of the word “horrible” to the word “performance” in determining a car's performance component score.

The following table lists some sample editorial evaluation component scores for cars in the class of affordable large SUVs.

TABLE 1

| | | | | | Interior |
|---|---|---|---|---|---|
| | | | | | Comfort |
| Make of | Model of | | Source of Editorial | Performance | Component |
| Car | Car | Class | Evaluation | Component Score | Score |
| Chevrolet | Suburban | Affordable Large SUVs | The Kansas City Star | 5 | 5 |
| Chevrolet | Suburban | Affordable Large SUVs | The Orlando Sentinel | 5 | 5 |
| Chevrolet | Tahoe | Affordable Large SUVs | Automobile Magazine | 5 | 4 |
| Chevrolet | Tahoe | Affordable Large SUVs | Edmunds | 5 | 4 |

According to an exemplary embodiment of the invention, each editorial evaluation for the item can provide component scores for various criteria. For example, for cars, the component scores can include: (1) overall recommendation; (2) performance; (3) interior comfort; (4) features; and (5) exterior. According to an exemplary embodiment, the scores can be between 0 (worst) and 6 (best), or N/A for not applicable for each of the component scores. It should be noted, however, that the method is not limited to the 0-6 scale, and that other scales are possible.

Referring to block 130 of FIG. 1, the scores generated by step 120 can be transformed to a different scale, for example, from a 0-6 scale to a 0-10 point scale. This can be done, for example, using simple multiplication. The transformation step 120, if applied, can normalize the scores from various sources and can simplify any subsequent weighing processes. The following table lists the scores from Table 1, above, transferred from a 0-6 point scale to a 0-10 point scale.

TABLE 2

| Make of | Model of | | Source of Editorial | Scaled Performance | Scaled Interior Comfort |
|---|---|---|---|---|---|
| Car | Car | Class | Evaluation | Component Score | Component Score |
| Chevrolet | Suburban | Affordable | The Kansas City | 8.33 | 8.33 |
| | | Large SUVs | Star | | |
| Chevrolet | Suburban | Affordable | The Orlando | 8.33 | 8.33 |
| | | Large SUVs | Sentinel | | |
| Chevrolet | Tahoe | Affordable | Automobile | 8.33 | 6.67 |
| | | Large SUVs | Magazine | | |
| Chevrolet | Tahoe | Affordable | Edmunds | 8.33 | 6.67 |
| | | Large SUVs | | | |

Referring to block 140 of FIG. 1, the editorial evaluation scores generated by each source can be weighted based on various factors. The weightings can represent the relative importance that each source may have in the calculation of final component scores, overall score, and/or rankings. The component scores can be weighted by, for example, the credibility of the source of the evaluation, and/or by the age of the evaluation. According to an exemplary embodiment, the applied weightings can be determined based on the judgment of an analyst. Additionally or alternatively, the applied weightings can be determined based on external factors, such as consumer surveys or algorithms that take into account the value of each source to the consumer. By weighting the most favored sources of editorial evaluations (e.g., Consumer Reports or Car and Driver) more strongly than less credible sources (e.g., consumer reviews), preference can be given to the sources of information that consumers should and/or do look to for trusted information. By weighting older editorial evaluations lower, more recent editorial evaluations gain importance in the final scoring of the item.

At the end of the step 100, each item being scored will have a weighted overall score, and/or a set of weighted component scores (for the variety of sub-criteria being considered) from each of the editorial evaluations obtained in step 110 and manipulated in steps 120-140.

Quantitative Ratings

An exemplary embodiment of obtaining quantitative ratings is shown in block 200 in FIG. 1. The term “quantitative rating” refers generally to data on a quantified or relative scale that evaluates certain aspects or criteria of the items of interest. Quantitative ratings differ from editorial evaluations primarily in that they are quantitative or scalar in nature (e.g. on a scale of 0-10, or a scale of worst-best) instead of being primarily word-based and descriptive of the item. Quantitative ratings are typically prepared by government agencies, independent third-party companies, or other organizations after testing and evaluation of the item(s). Examples of quantitative ratings include NHTSA crash test ratings, IIHS crash test ratings and USCPSC ratings.

Quantitative ratings can be obtained from a variety of sources that provide data relevant to the item of interest, as represented by block 210 of FIG. 1. According to an exemplary embodiment, the data can be obtained from preferred quantitative rating sources, which can be selected, for example, using the same or similar criteria as is used to determine preferred editorial evaluation sources (described above).

According to an exemplary embodiment, the quantitative ratings can relate to the same criteria (component scores) as the editorial evaluation scores. Alternatively, the quantitative ratings can relate to additional or different component scores. Examples of criteria addressed by third-party quantitative ratings can include: (1) safety; (2) reliability; and (3) value. The following table lists some third-party quantitative ratings for cars.

TABLE 3

| | | NHTSA | | | | |
|---|---|---|---|---|---|---|
| | NHTSA | Front crash | NHTSA Side | | | |
| | Front crash | test - front | crash test - | IIHS Top | IIHS Front | IIHS Side |
| Car Model | test - driver | passenger | front | Safety Pick | (Overall) | (Overall) |
| 2007_Acura_MDX | 5 | 5 | 5 | | Good | |
| 2007_Acura_RDX | 5 | 5 | 5 | Yes | Good | Good |
| 2007_Acura_RL | 5 | 5 | 5 | | Good | |
| 2007_Acura_TL | 5 | 5 | 4 | | Good | Good |

Once the third-party quantitative ratings have been collected in step 210, the ratings can be standardized into component scores, as represented by block 220. For example, the quantitative ratings can be standardized to a 0-10 scale using, e.g., simple multiplication. With respect to quantitative ratings using a word-based or similar scale, a simple mapping table can be used to map a word, such as “good” to a number in this method's final outcome that equates to “good.” For example, the word-based score of “good” may be mapped to a numerical score of 9.5. The following table lists third-party quantitative ratings from Table 3 after standardization.

TABLE 4

| | | NHTSA | | | | |
|---|---|---|---|---|---|---|
| | NHTSA | Front crash | NHTSA Side | | | |
| | Front crash | test - front | crash test - | IIHS Top | IIHS Front | IIHS Side |
| Car Model | test - driver | passenger | front | safety Pick | (Overall) | (Overall) |
| 2007_Acura_MDX | 10.0 | 10.0 | 10.0 | | 9.5 | |
| 2007_Acura_RDX | 10.0 | 10.0 | 10.0 | 9.5 | 9.5 | 9.5 |
| 2007_Acura_RL | 10.0 | 10.0 | 10.0 | | 9.5 | |
| 2007_Acura_TL | 10.0 | 10.0 | 7.6 | | 9.5 | 9.5 |

In the case where ratings exist for sub-components of component scores, but not for the component scores themselves (e.g., data exists for braking and acceleration, but not for performance), the sub-component data can be averaged together to obtain the respective component data. Additionally or alternatively, when ratings correspond to component scores, but not to an overall score, the component scores can be averaged together to obtain an overall score from the source of the quantitative rating. When averaging component scores or sub-component scores, weightings may be applied to various sub-components to reflect, for example, consumer preferences. The consumer preferences may be obtained, for example, from consumer surveys or other sources. In the case where component data exists in addition to the underlying sub-component data (e.g., data exists for performance, braking, and acceleration), the component data can be used and the sub-component data can be ignored.

According to an exemplary embodiment, all data points across items being scored that are 100% identical can be removed for simplicity, since their value will not differentiate the items in downstream calculations. For example, in the case where a source of third-party data provides the same score for all items for a given criteria, the data from that source can be disregarded for that criteria. This is the case with the data in the “NHTSA Front crash test-driver” column of Table 4, above.

Referring still to FIG. 1, the standardized quantitative ratings obtained from step 220 can be weighted based on the source they came from, as shown in block 230. According to an exemplary embodiment, the weighting can be based on a 0 to 1 scale, and can be applied to each component value multiplicatively, however, other scales and mathematical operations are possible. Factors to be considered for the weighting step 230 can include the credibility of the source, and/or the age of the quantitative ratings, although other factors are possible as will be appreciated by one of ordinary skill in the art.

At the completion of step 200, each item being scored will have a weighted overall score, and/or a set of weighted component scores, from each of the sources of third-party quantitative ratings obtained in step 210 and manipulated in steps 220 and 230.

Combining Scores

After the steps shown in blocks 100 and/or 200 of FIG. 1 are complete, the resulting editorial evaluation scores and/or the quantitative ratings can be combined for each item being scored. This step is depicted in block 300 of FIG. 1. This can include combining all of the scores obtained from editorial evaluations (step 100) to obtain final component scores and/or and overall score for each item being scored. Alternatively, this can include combining all of the scores obtained from quantitative ratings (step 200) to obtain final component scores and/or an overall score for each item being scored. Still alternatively, this can include combining the scores from the editorial evaluations (step 100) with the scores from the quantitative ratings (step 200) to obtain final component scores and/or an overall score for each item being scored.

According to the exemplary embodiment where editorial evaluation scores are combined with quantitative ratings, additional weightings can be applied, as represented by block 310. For example, to prevent editorial evaluation scores from overwhelming quantitative ratings in calculating component scores and/or overall scores, and vice versa, a mathematical transformation (e.g., a square root or exponential transformation) can be applied to the data points from each type of score. For example, if there are 81 data points for the quantitative ratings for a given item (e.g., scores derived from 81 different quantitative rating sources for a given item), and 9 data points for editorial evaluation scores (e.g., scores derived from 9 different editorial evaluation sources for a given item), a weight of 3 will be applied to the quantitative ratings. As a result, the quantitative ratings will outweigh the editorial evaluation scores by a factor of 3 instead of a factor of 9.

Editorial evaluation scores and quantitative ratings scores can additionally or alternatively be weighted based on how much the respective type of data should bear on a given criteria (e.g., component score). For example, it may be appropriate for a component score such as safety to rely more on quantitative ratings than on editorial evaluation scores, in which case the quantitative ratings for safety can be weighted (e.g., multiplicatively) more heavily than the editorial evaluation scores for safety. On the other hand, it may be more appropriate for the component score for interior comfort to rely more on editorial evaluation scores than on quantitative ratings, in which case the editorial evaluation scores can be weighted more heavily.

Referring still to FIG. 1, block 320 represents an exemplary step of combining scores, which comprises weight-averaging the scores. The weight averaging can apply when editorial evaluation scores are combined with quantitative ratings. Alternatively, it can apply when editorial evaluation scores are relied on exclusively, or when quantitative ratings are relied on exclusively.

When both types of data are being combined, the editorial evaluation scores relating to each component score can be weight-averaged with the quantitative ratings relating to the same component score. This can be performed for each item being reviewed, as well as for each criteria (component score) being considered. Before or while combining scores, the appropriate weightings, if any, can be applied (e.g., multiplicatively). The scores for the same criteria are averaged together. The result is a weight-averaged score for a given criteria (e.g., all scores for the criteria of performance can be weight-averaged to obtain the component score for performance). This can be done for each criteria considered in the analysis, to obtain a set of component scores for each item being scored. Alternatively, this can be done using just the overall score from each source, when component scores are not being considered.

The following table lists sample component scores for four cars scored on the criteria of safety, performance, interior, exterior, reliability, and overall recommendation.

TABLE 5

| | Safety | Performance | Interior | Exterior | Reliability | Overall |
|---|---|---|---|---|---|---|
| | Component | Component | Component | Component | Component | Recommendation |
| Car Model | Score | Score | Score | Score | Score | Component Score |
| 2007_Acura_MDX | 9.5 | 8.7 | 8.8 | 9.1 | 9.5 | 9.4 |
| 2007_Acura_RDX | 9.6 | 8.8 | 8.1 | 9.5 | 9.1 | 9.3 |
| 2007_Acura_RL | 9.4 | 8.5 | 7.9 | 7.9 | 8.6 | 8.8 |
| 2007_Acura_TL | 9.5 | 8.4 | 7.6 | 7.6 | 8.6 | 8.1 |

Calculating Overall Scores

In the case where overall scores are being calculated on a set of component scores, the overall score for each item can be calculated, for example, using a weight-average of the item's component scores. According to an exemplary embodiment, the weights applied to the various component scores total 100%. The weight-average, if used, can be based on the relative importance consumers, businesses, etc., place on each of the component scores when purchasing or choosing the item. For example, car buyers may place more importance on a car's reliability than on its performance, and this can be taken into consideration in applying the weights.

According to an exemplary embodiment, the relative weights can be obtained by performing a statistically representative survey of the population interested in the item being scored (e.g., the car buying population). The surveys can be updated periodically to reflect changes in the marketplace.

According to another exemplary embodiment, the relative weights can be obtained interactively, for example, by using a computer interface, such as an Internet browser. For example, the user can order the different criteria (i.e., component scores) in order of preference using pull down menus or other features. Alternatively, the user can type in numerical values indicating the relative importance of each component score. The computer interface can then apply the weightings to the respective component scores to obtain the overall score.

The overall score for each item can be calculated by multiplying each component score by its respective weight, and adding the weighted component scores. (For example, 25%*Safety Score+12.3%*Performance Score+25.0%*Reliability Score+other scores and/or factors.)

The following table lists sample overall scores based on applying the above-described weight-averaging process.

TABLE 6

| Model | Overall score |
|---|---|
| 2007_Acura_MDX | 9.6 |
| 2007_Acura_RDX | 9.4 |
| 2007_Acura_RL | 9.1 |
| 2007_Acura_TL | 9.0 |

Ranking Items

The present method can also include the step of ranking multiple items based, for example, on their overall scores. Block 500 of FIG. 1 represents the step of ranking the items. According to an exemplary embodiment, the items can be ranked sequentially based on their overall score, where the item within the highest overall score receives the lowest ranging (i.e., number 1 out of 4, or best) and the item with the lowest overall score receives the highest ranking (e.g., number 4 out of 4, or worst). The following table lists sample rankings based on the overall scores shown in Table 6, above.

TABLE 7

| Model | Ranking |
|---|---|
| 2007_Acura_MDX | 1 |
| 2007_Acura_RDX | 2 |
| 2007_Acura_RL | 3 |
| 2007_Acura_TL | 4 |

Additionally or alternatively, the items can be sub-ranked based on their component scores. For example, the cars used throughout to illustrate the present method can be ranked based on their performance component score, or on their safety component score. Additionally or alternatively, the items can be sub-ranked based on groupings or subsets of their component scores.

The various method steps described heretofore can be performed automatically, for example, using a computer, computer software, etc., as will be described in more detail below. Alternatively, a person or group of people can perform the steps manually. Still alternatively, the steps can be implemented by a combination of automatic and manual processing.

Publishing the Scores and/or Rankings

According to exemplary embodiments of the invention, some or all of the results of the above method can be displayed on the web (either statically or interactively), published in printed form, or broadcasted as sound or video. One of ordinary skill in the art will appreciate that other methods for displaying the scores and/or rankings of the present invention are also possible.

Scores and rankings may be obtained from a variety of sources in accordance with an exemplary embodiment of the invention. The items shown in the examples set forth herein are cars, and the product category is “upscale midsize cars,” however, scores and rankings for many different types of items could be analyzed and displayed in the same or a similar manner. The cars are ranked from 1 to 10 by their overall score, with the ranking of 1 being the highest and 10 being the lowest. In the exemplary embodiment shown, a word score equating to the numerical overall score is also included (e.g., the overall score of 9.2 equates to “excellent”). The underlying component scores may also be listed for each item. In the exemplary embodiment shown, the component scores are for the respective car's “performance”, “interior”, “reliability”, “exterior”, and “safety”. Additional information for each item can also be displayed, such as, for example, the price and expected gas mileage. One of ordinary skill in the art will appreciate that such information can be displayed in many different formats and on different media, for example, in printed publications such as books or magazines, or in video or interactive formats.

One of ordinary skill in the art will appreciate that the invention is not limited to the exemplary formats shown herein. The invention is not limited to any specific manner, format, etc., of publishing the results of the scoring and ranking process, nor is publishing the results required.

Updating the Scores and/or Rankings

The scores and/or rankings obtained the method described herein can be updated as new information about items becomes available. For example, as new editorial evaluations or quantitative ratings become available for a given item, the new information can be incorporated into the scoring and/or ranking process. Additionally or alternatively, consumer preferences can be surveyed on an ongoing basis, and any weightings reflecting those preferences can be updated. These updating steps can be implemented manually by people, automatically, such as by a computer, or by some combination of the two.

Description of Computer and Related Items

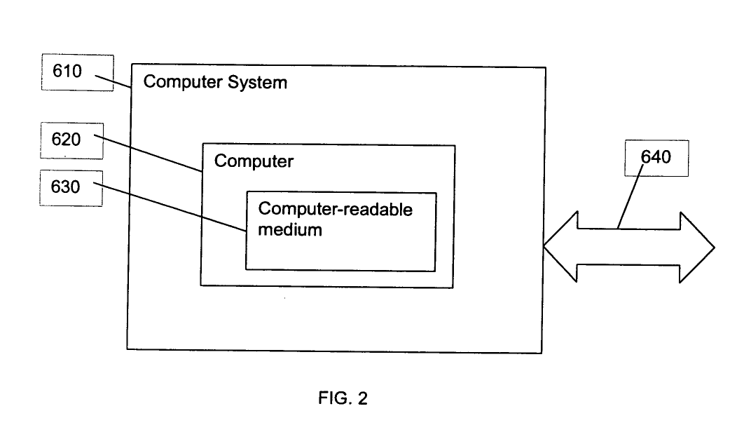

FIG. 2 depicts an exemplary computer system that can be used to implement embodiments of the invention. The computer system 610 may include a computer 620 for implementing aspects of the exemplary embodiments described herein. The computer 620 may include a computer-readable medium 630 embodying software for implementing the invention and/or software to operate the computer 620 in accordance with the invention. As an option, the computer system 610 may include a connection to a network 640. With this option, the computer 620 may be able to send and receive information (e.g., software, data, documents) from other computer systems via the network 640.

Exemplary embodiments of the invention may be embodied in many different ways as a software component. For example, it may be a stand-alone software package, or it may be a software package incorporated as a “tool” in a larger software product. It may be downloadable from a network, for example, a website, as a stand-alone product. It may also be available as a client-server software application, or as a web-enabled software application.

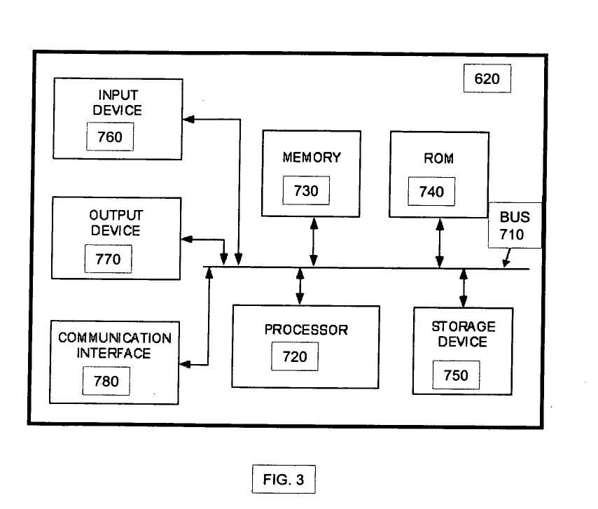

FIG. 3 depicts an exemplary architecture for implementing the computer 620 of FIG. 2. It will be appreciated that other devices that may be used with computer 620, such as a server, or a client, may be similarly configured. As illustrated in FIG. 3, the computer 620 may include a bus 710, a processor 720, a memory 730, a read only memory (ROM) 740, a storage device 750, an input device 760, an output device 770, and/or a communication interface 780.

Bus 710 may include one or more interconnects that permit communication among the components of computer 620. Processor 720 may include any type of processor, microprocessor, or processing logic that may interpret and execute instructions (e.g., a field programmable gate array (FPGA)). Processor 720 may include a single device (e.g., a single core) and/or a group of devices (e.g., multi-core). Memory 730 may include a random access memory (RAM) or another type of dynamic storage device that may store information and instructions for execution by processor 720. Memory 730 may also be used to store temporary variables or other intermediate information during execution of instructions by processor 720.

ROM 740 may include a ROM device and/or another type of static storage device that may store static information and instructions for processor 720. Storage device 750 may include a magnetic disk and/or optical disk and its corresponding drive for storing information and/or instructions. Storage device 750 may include a single storage device or multiple storage devices, such as multiple storage devices operating in parallel. Moreover, storage device 750 may reside locally on computer 620 and/or may be remote with respect to computer 620 and connected thereto via a network and/or another type of connection, such as a dedicated link or channel.

Input device 760 may include any mechanism or combination of mechanisms that permit an operator to input information to computer 620, such as a keyboard, a mouse, a touch sensitive display device, a microphone, a pen-based pointing device, and/or a biometric input device, such as a voice recognition device and/or a finger print scanning device. Output device 770 may include any mechanism or combination of mechanisms that outputs information to the operator, including a display, a printer, a speaker, etc.

Communication interface 780 may include any transceiver-like mechanism that enables computer 620 to communicate with other devices and/or systems, such as a client, a server, a license manager, a vendor, etc. For example, communication interface 780 may include one or more interfaces, such as a first interface coupled to a network and/or a second interface coupled to a license manager. Alternatively, communication interface 780 may include other mechanisms (e.g., a wireless interface) for communicating via a network, such as a wireless network. In one implementation, communication interface 780 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computer 620 may perform certain functions in response to processor 720 executing software instructions contained in a computer-readable medium, such as memory 730. In alternative embodiments, hardwired circuitry may be used in place of or in combination with software instructions to implement features consistent with principles of the invention. Thus, implementations consistent with principles of the invention are not limited to any specific combination of hardware circuitry and software.

In an exemplary embodiment of the present invention, computer system 610 may be used as follows. Input device 760 may be used for the input of editorial evaluations, which are processed in accordance with the present invention by processor 720 to produce evaluation scores. Communication interface 780 may also be used to access editorial evaluations and/or quantitative ratings from remote sources, using network connection 640. The evaluation scores and/or quantitative ratings may be further processed by processor 720 to produce overall or component scores as may be appropriate. The overall or component scores may in turn be presented to a user by output device 770 or stored on storage device 750.

While various exemplary embodiments have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed:

1. A method of scoring an item, comprising:
(a) reviewing a first editorial evaluation of the item;
(b) assigning a first editorial evaluation score to the item based on the first editorial evaluation;
(c) reviewing a second editorial evaluation of the item;
(d) assigning a second editorial evaluation score to the item based on the second editorial evaluation; and
(e) calculating a score for the item based on the first editorial evaluation score and the second editorial evaluation score.

2. The method of claim 1,
where the editorial evaluation is comprised of a qualitative review of the item;
wherein step (a) comprises analyzing the qualitative review and identifying at least one editorial value within the editorial evaluation; and
where step (b) comprises applying a set of rules to the at least one editorial value.

3. The method of claim 1, wherein step (e) comprises calculating an overall score for the item.

4. The method of claim 1, wherein step (b) comprises assigning a first set of editorial evaluation component scores to the item, and step (d) comprises assigning a second set of editorial evaluation component scores to the item.

5. The method of claim 4, wherein step (e) comprises calculating a set of component scores for the item based on the first set of editorial evaluation component scores and the second set of editorial evaluation component scores.

6. The method of claim 5, further comprising calculating an overall score for the item based on the set of component scores.

7. The method of claim 6, wherein calculating the overall score for the item applies a weighting for each component score.

8. The method of claim 7, wherein the weighting for each component score is based upon a ranking of components by an individual seeking the overall score for the item.

9. The method of claim 1, further comprising:
(f) scoring a second item using steps (a) through (e); and
(g) ranking the first item against the second item based on their respective scores.

10. The method of claim 1, further comprising obtaining a quantitative rating of the item, wherein the step (e) further comprises calculating a score for the item based on the first editorial evaluation score, the second editorial evaluation score, and the quantitative rating for the item.

11. The method of claim 10, wherein the step (e) further comprises weighting at least one of the first editorial evaluation score, the second editorial evaluation score, and the quantitative rating.

12. The method of claim 11, wherein the weighting is based on at least one of: (i) the source of the first editorial evaluation, (ii) the source of the second editorial evaluation, and (iii) the source of the quantitative rating.

13. The method of claim 11, wherein the weighting is based upon a ranking of factors by an individual seeking the score for the item.

14. A method of scoring an item, comprising:
(a) obtaining a first editorial evaluation of the item;
(b) reviewing the first editorial evaluation of the item;
(c) assigning a first editorial evaluation score to the item based on the first editorial evaluation;
(d) obtaining a first quantitative rating of the item; and
(e) calculating a score for the item based on the first editorial evaluation score, and the first quantitative rating for the item.

15. The method of claim 14, further comprising:
in step (a), obtaining a second editorial evaluation of the item;
in step (b), reviewing the second editorial evaluation of the item;
in step (c), assigning a second editorial evaluation score to the item based on the second editorial evaluation; and
in step (e), calculating the score for the item based on the first editorial evaluation, the second editorial evaluation and the first quantitative rating for the item.

16. The method of claim 14, further comprising:
in step (d), obtaining a second quantitative rating of the item; and
in step (e), calculating the score for the item based on the first editorial evaluation, the first quantitative rating and the second quantitative rating for the item.

17. The method of claim 14:
where the first editorial evaluation is comprised of a qualitative review of the item;
wherein step (b) comprises analyzing the qualitative review and identifying at least one first editorial value within the first editorial evaluation; and
where step (c) comprises applying a set of rules to the first editorial value.

18. A method of scoring an item, comprising:
(a) obtaining a first quantitative rating of the item;
(b) obtaining a second quantitative rating of the item; and
(c) calculating a score for the item based on the first quantitative rating and the second quantitative rating.

19. The method of claim 18 further comprising:
(d) obtaining a first editorial evaluation of the item;
(e) assigning a first evaluation score to the item based on the first editorial evaluation; and
(f) calculating a second score for the item based on the first quantitative rating, the second quantitative rating and the first evaluation score.

20. A method of scoring an item comprising:
(a) obtaining a plurality of editorial evaluations of the item;
(b) assigning an evaluation score to each of the editorial evaluations; and
(c) calculating a score for the item based upon the evaluation scores.

21. The method of claim 20, further comprising:
(d) obtaining a plurality of quantitative ratings of the item; and
(e) calculating a score for the item based upon the evaluations scores and the quantitative ratings.

22. The method of claim 20,
where the plurality of editorial evaluations are each comprised of a qualitative review of the item;
wherein step (b) comprises analyzing the qualitative reviews for each of the plurality of editorial evaluations and identifying at least one editorial value within each editorial evaluation, and applying a set of rules to the at least one editorial value.

23. A method of computerized scoring of an item comprising:
(a) input of a first editorial evaluation of the item into a computer input;
(b) processing the first editorial evaluation of the item to extract a first set of evaluation data thereof;
(c) assigning a first editorial evaluation score to the item based on the first set of evaluation data;
(d) input of a first quantitative rating of the item;
(e) calculating a score for the item based on the first editorial evaluation score and the first quantitative rating for the item; and
(f) displaying the score for the item on a computer display.

24. The method of claim 23:
where the first editorial evaluation is comprised of a qualitative review of the item; and
wherein step (b) comprises analyzing the qualitative review and identifying at least one first editorial value within the first editorial evaluation, and applying a set of rules to the at least one first editorial value.
